(19) United States
(12) Patent Application Publication
(10) Pub. No.: US 2012/0198388 A1
(43) Pub. Date: Aug. 2, 2012

(54) THREE DIMENSIONAL SYSTEM FOR MANAGING INFORMATION IN ELECTRONIC DEVICES AND METHODS THEREOF

(76) Inventor: Fernando Santesteban, Vicente Lopez (AR)

(21) Appl. No.: 13/015,111

(22) Filed: Jan. 27, 2011

(51) Int. Cl. G06F 3/048

(52) U.S. Cl. 715/849

(57) ABSTRACT

Generally described, the present application relates to managing information in electronic devices. More specifically, the present application relates to a three dimensional dynamic system for visualizing and navigating through files. In one illustrative embodiment, the system displays information from a database or any other collection of records with different attributes in a three dimensional layout. Objects, typically spheres, can represent groups of items or records with similar characteristics according to defined attributes in the three dimensional layout. On a fourth axis, representing a separate attribute, a time related characteristic can be associated with the objects. Other attributes can be used as well. The objects can also be provided in different colors or patterns to reflect other characteristics within the records. A navigation interface can be used to rotate, pan, zoom-in, zoom-out and crop the three dimensional layout. The navigation plane can also provide access to files referenced by the objects.

### TECHNICAL FIELD

This application generally relates to a user interface, and more particularly, to a three dimensional dynamic system for visualizing, navigating and managing info nation in electronic devices.

### BACKGROUND

Memory, a core component of computing devices, has increased continuously since the invention of the first electronic switches. At the current rate, computer memory exponentially improves every couple of years and will continue to do so. Computer memory can store almost anything in an electronic or magnetic way. For example, typical computer users maintain pictures, music, movies, files, contacts, to-do lists, mail, phone numbers, addresses, Internet web pages addresses and a lot more. Compounding this information can take gigabytes of information.

Most operating systems maintain a folder system mimicking a hierarchical directory tree. The folders are presented visually in a format having main folders and subfolders therein to contain the information. The tree like directory arrangements are convenient when there is a clearly defined hierarchy. However, when data cannot be easily classified, the user is forced to search in many different branches of the tree to look for the desired piece of information. Organizationally, the folders are static in nature. Because of this, locating files, and managing and controlling the information can become difficult. Often this leads to frustrations, for example, looking up a file named “Trip to Rome 2005” can possibly be found in folders named Trips, Rome, Holidays, Vacation or Europe.

There are several other user interfaces in the current market that have a three-dimensional effect and can show or represent shapes and figures in three dimensions. These interfaces, however, do not take full advantage of this three dimensional scenario. They merely allow the user to navigate in two dimensions in a three dimensional landscape. The present application, on the other hand, can allow the user to virtually navigate in a three dimensional environment, being able to move up or down, left or right and nearer or farther away, thus providing the sensation of really “flying” in the environment.

Therefore, what is needed is a system and method for easily and intuitively grouping, sorting and filtering this information. An aid is desirable for anyone who regularly uses computers, music players, video players, browses the Internet, enjoys looking at an electronic photo album, watches TV, listens to the radio, etc. The present application provides these abilities as well as discloses other related advantages.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a user computer system having a display screen and a graphical user interface provided for on the display screen for navigating through a plurality of files is provided. The system can include at least one processor and a memory operatively coupled to the processor, the memory storing program instructions that when executed by the processor, causes the processor to perform processes. The processes can include determining at least three attributes for the plurality of files and associating characteristics of the at least three attributes to an x-axis, y-axis and z-axis on a three dimensional space in the graphical user interface. In addition, the processes can include mapping at least one object on the three dimensional space in the graphical user interface indicating a number of files from the plurality of files having common characteristics defined at an intersection of the characteristics associated with the at least three attributes on the x-axis, y-axis and z-axis.

In accordance with another aspect of the present application, a computer-implemented method for visualizing records is provided. The method can include determining at least one attribute for the records and associating at least one axis with characteristics of the at least one attribute. In addition, the method can include deciding on a number of records that have at least one common characteristic according to the characteristics of the at least one attribute and generating at least one object according to the decision. The method can also include mapping the at least one object at the at least one common characteristic associated with the characteristics of the at least one attribute on the at least one axis.

In accordance with yet another aspect of the present application, a system for organizing and traversing through files using logic executed by at least one processor is provided. The system can include cube representation logic defining an x-axis, y-axis and z-axis on a three dimensional space, the x-axis, y-axis and z-axis each associated with an attribute having characteristics. In addition, the system can include generation logic defining at least one sphere indicating a number of files associated with characteristics of the attributes on the x-axis, y-axis and z-axis, the at least one sphere placed within the three dimensional space corresponding to the characteristics of the attributes on the x-axis, y-axis and z-axis. The system can also include navigating logic defining options for visualizing the at least one sphere on the three dimensional space.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is an exemplary graphical representation of files in a computer disk illustratively grouped and sorted by a filename's first letter on a line representation in accordance with one embodiment of the present application;

FIG. 2 is an exemplary graphical representation of the files in a computer disk illustratively grouped and sorted by a filename's first letter and by a file extension on a plane representation in accordance with one embodiment of the present application;

FIG. 3 is an exemplary graphical representation of the files in a computer illustratively grouped and sorted by a filename's first letter, file extension and owner on a cube representation in accordance with one embodiment of the present application;

FIG. 4 depicts illustrative controls for viewing the three dimensional interface in accordance with one embodiment of the present application;

FIG. 5 provides an exemplary navigation interface in accordance with one embodiment of the present application;

FIG. 6 illustrates features and relational data for an exemplary sphere in accordance with one embodiment of the present application;

FIG. 7 depicts exemplary objects clustered for use with the illustrative graphical representation of files in accordance with one embodiment of the present application; and

FIG. 8 is an exemplary block diagram that shows an illustrative computer architecture used for running the three dimensional interface in accordance with one aspect of the present application.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

Generally described, the present application relates to managing information in electronic devices. More specifically, the present application relates to a three dimensional color and dynamic system for visualizing and navigating through files or other information such as television or radio channels. The system and methods can also use patterns. In one illustrative embodiment, the system displays information from a database or any other collection of records with different attributes in a three dimensional layout. Objects, typically spheres, can represent groups of items or records with similar characteristics according to defined attributes in the three dimensional layout. In some embodiments, the objects can include balloons, balls, planets, fruits, books, cars, toys, etc. Representing a separate attribute, time related characteristics can also be associated with the objects. The objects can also be provided in different colors or patterns to reflect other characteristics within the records. A navigation pane can be used to rotate, pan, zoom-in, zoom-out and crop the three dimensional layout. The navigation pane can also provide access to files referenced by the objects.

Numerous advantages can be provided through the system illustrated above. Data can be collected from the hierarchical directory structures where data items are stored in different branches of a tree-like arrangement or the system can be used in data structures where all the information is saved in one place. Some additional advantages include accessing data through different routes. For example, a file named “Trip to Rome 2005” can be found through characteristics Trips, Rome, Holidays, Vacation or Europe.

The term characteristic can refer to an element within an attribute. Typically, attribute can include a grouping of one or more characteristics. Those skilled in the relevant art will appreciate that attributes and characteristics can be known by other terms. For purposes of illustration, and to further clarify the attribute/characteristic distinction, an attribute can refer to the extension of a file. Associated characteristics could therefore refer to image files, document files, movie files, spreadsheet files, etc. Numerous other examples will be provided below to further clarify the distinctions between attributes and characteristics.

Files can be classified with one or many attributes. In the case of software filing systems these attributes can be, but are not limited to, filename, first filename letter, file size, date created, date modified, file extension, author, owner, duration, subject, category or any other existing or user defined property. Those skilled in the relevant art will appreciate that the system can extend beyond information stored in files, for example, records can be used. Beyond default information associated with files or records, records or files can also be associated with other types of attributes created or assigned by the user, for example, “Category”, “Place”, “Project”, “Customer”, “Supplier”, “Type of Document”, etc.

Directory-type or contact information attributes can include but are not limited to: last name, first name, middle name, street name, street number, city, zip code, country, home phone number, work phone number, cell phone number, nickname, date of birth or any other attribute or user defined property. In the case of mail related information, such as that stored in an inbox, outbox, sent items or any other type of folder that could contain mail, attributes can include but are not limited to: subject, sender, receiver, date sent, date received, read flag, importance flag, size or any other user defined property. In the case of task lists, attributes can be but are not limited to: subject, importance, start date, due date, reminder flag, reminder date, notes, or any other task or user defined property. In the case of music this attributes can be but are not limited to: album, band, author, composer, year of release, track number, track title, track duration, track size, genre, category, playlist or any other attribute or user defined property.

Photo attributes can be but are not limited to: name, date taken, place taken, album, size, file extension, category or any other user defined property. In the case of movies, attributes can be but are not limited to: movie title, movie director, producer, year of release, main actor, main actress, secondary actor, secondary actress, genre, or any other attribute or user defined property. In the case of Internet web pages attributes can be but are not limited to: domain name, domain country extension, type of web page, IP address, secure or non secure domain flag, number of hits to that domain or any web page attribute or user defined property.

In one embodiment, the present application can be used as a program manager where the program attributes can be but are not limited to: program name, brand (Microsoft™, Adobe™, etc.), program size, frequency of use, last time used, category (tools, applications, utilities, games, etc.), user, etc. Another useful application can be to navigate and select television channels. In this application, television channels can be sorted and grouped by company (HBO, Disney, etc.), public to which it is directed (adult, children, teenagers), category (movies, documentaries, entertainment, etc.), duration, etc. Similar concepts can be used to browse and select radio channels.

Generally, these attributes can be used to visualize information contained in any kind of database in an intuitive and dynamic way. The information can be grouped by some of the aforementioned properties and each group can be represented by an object. The size of these objects will be related to the quantity of items they represent. For simplicity, through this application the objects will be spheres. However, those skilled in the relevant art will appreciate that other shapes can be used both in two dimensions as in three dimensions, such as rectangles, squares, ovals, books, cars, houses, toys, etc.

The spheres can have a radius proportional to the number of items they represent. Generally, these spheres can be sorted in one, two or three axes. The spheres can have one or many colors associated to properties of the items they represent. This can be achieved by using different colors on one single sphere that can be arranged horizontally, vertically or in spots. Another way can be by expanding each single colored sphere into many spheres, each one of them of a different color. Furthermore other file attributes can be associated to a timeline. This feature can work best with time-related attributes, such as year of creation, but it can also be used with any other attribute. With this feature, the user can be able to use a “fourth dimension,” that for simplicity, will be called “time.” Hence there can be spheres associated to each year of creation, or any other property. Panning the time line can create a succession of frames ball clusters in a dynamic, movie like fashion.

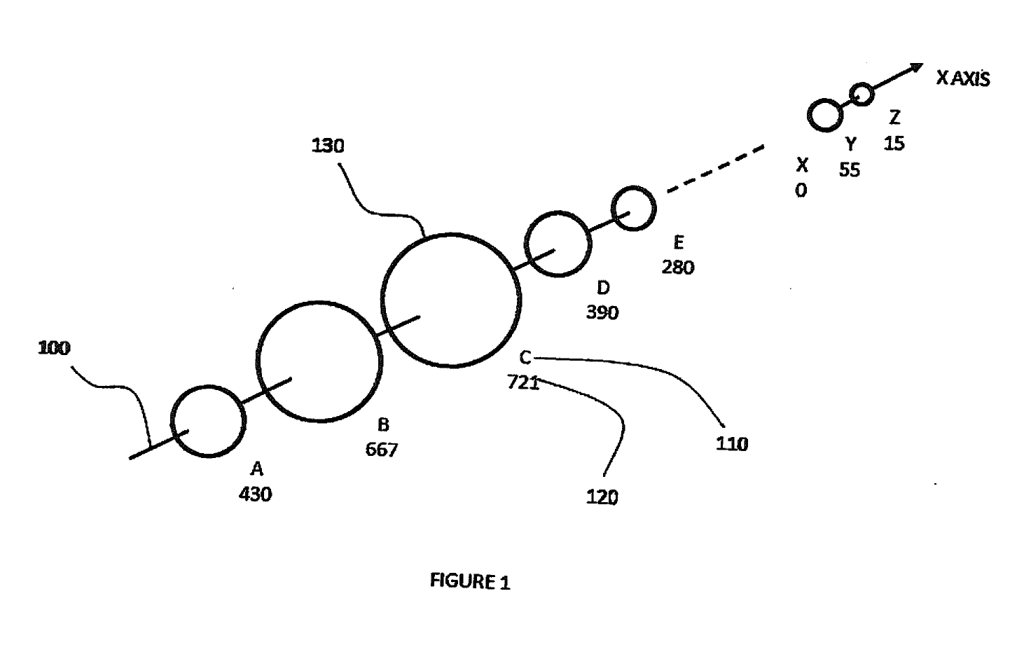

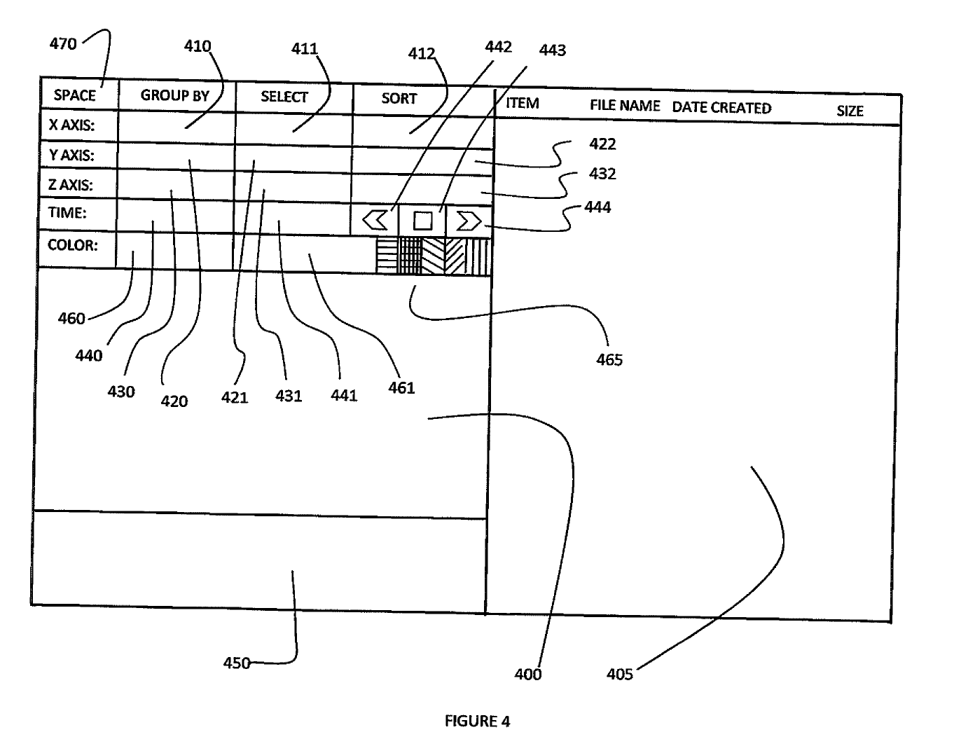

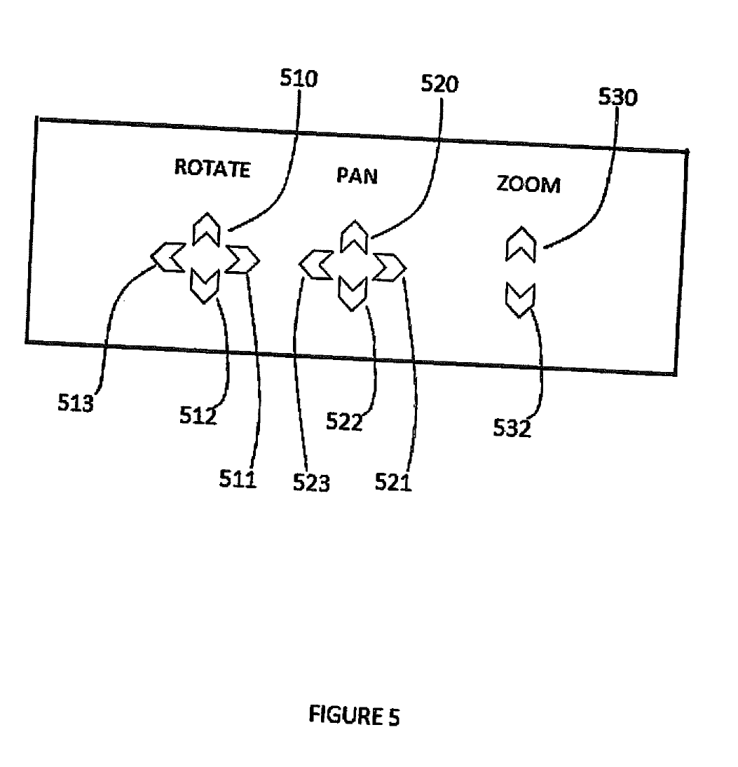

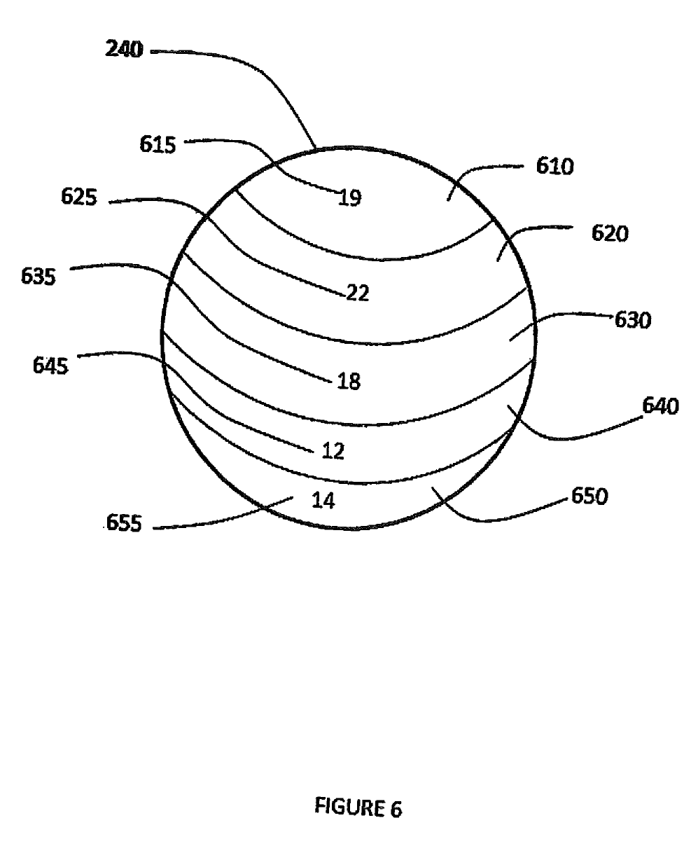

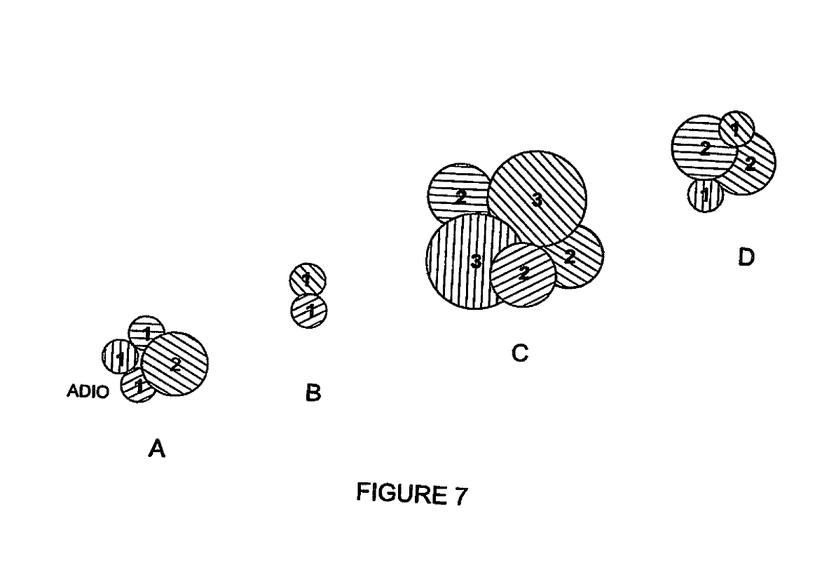

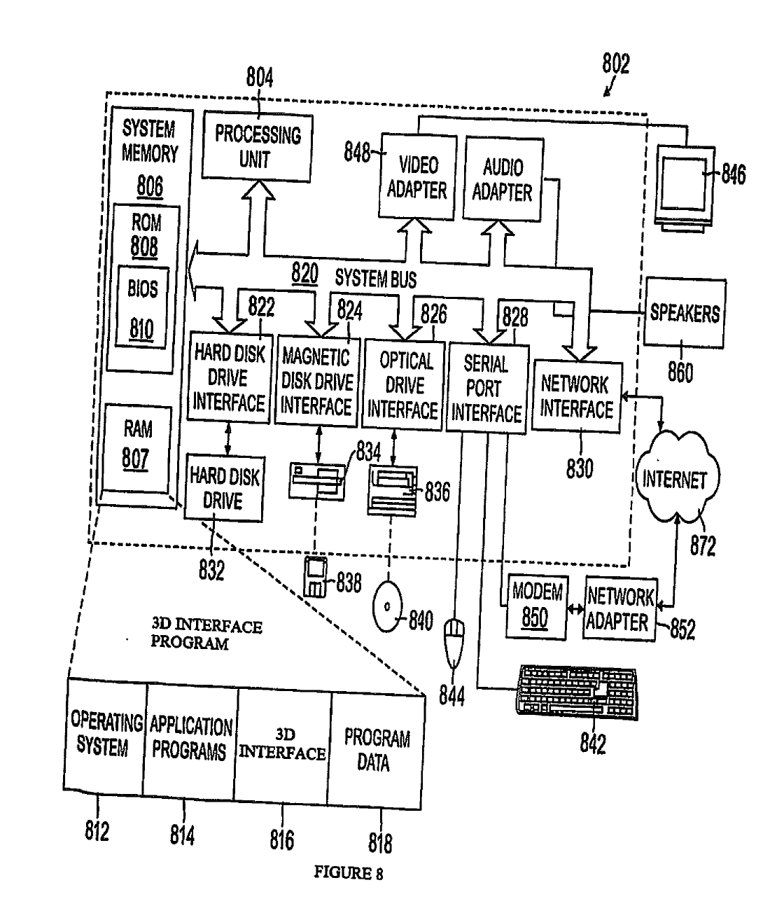

Many additional features and elements of the present application will become apparent to those of ordinary skill in the relevant art as provided for in the following description. Below, FIGS. 1 through 3 describe axes associated with attributes for use with objects that define a number of items, files or records associated with a set of characteristics. FIGS. 4 and 5 depict a navigation interface for manipulating the axes and objects. FIG. 6 shows a closer view of a single sphere with different colors or patterns. FIG. 7 shows a cluster of spheres of different colors or patterns and FIG. 8 shows exemplary hardware for use with the system.

FIG. 1 is an exemplary graphical representation of files in a computer disk illustratively grouped and sorted by a filename's first letter 110 on a line representation in accordance with one embodiment of the present application. While the embodiment shown is sorted and grouped according to the first letter 110 of the filename, those skilled in the relevant art will appreciate that other attributes can be used. The files can be found on a computer disk or retrieved from a remote server, the Internet, etc. The system can also be used with cloud-based computing environments.

The attribute of the first letter 110 of the filenames can be associated with the x-axis 100. Characteristics for the attribute can include A, B, C, D, E, . . . X, Y and Z 110 and marked on the x-axis 100 as shown. On the x-axis 100, objects 130 can be placed. Each object 130 can represent files whose filenames start with the letter 110 adjacent to the object 130. The objects 130, in one embodiment, are spheres. The number of files 120 represented by each sphere 130 can also be indicated. As this representation has only one dimension, it can be referred to as a “line representation” throughout the present application.

In other embodiments, the characteristics 110 can be placed directly within the objects 130 or other location that would improve readability by the user. In one embodiment, when no object 130 can be placed on the x-axis 100, no characteristic 110 can be marked on the x-axis 100. The number of files 120 can also be provided within the objects 130.

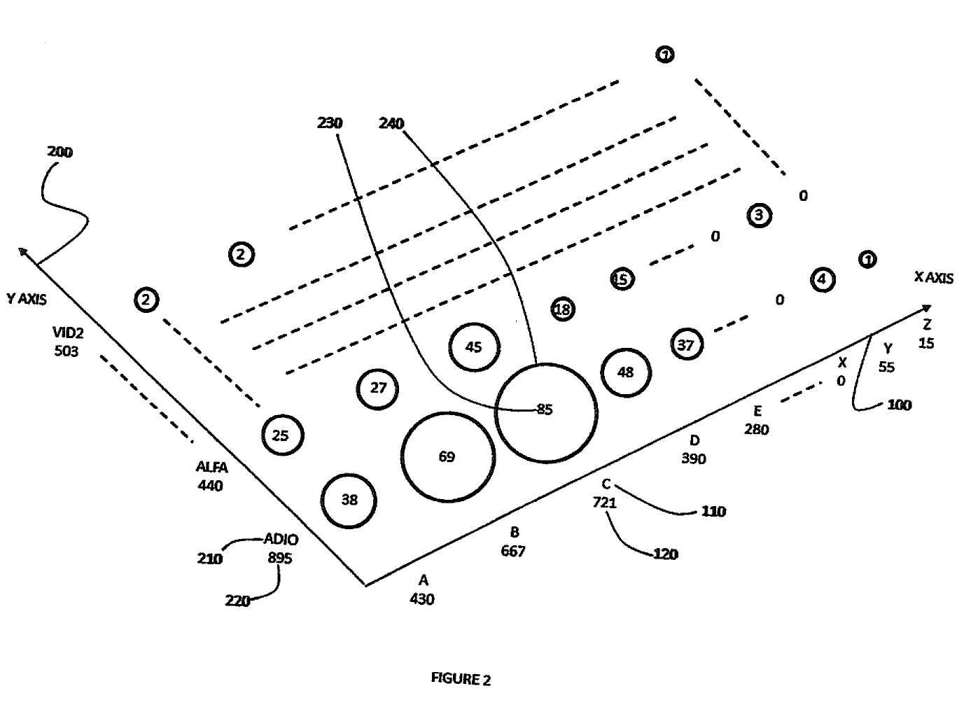

Turning to FIG. 2, an exemplary graphical representation of the files in a computer disk illustratively grouped and sorted by a filename's first letter 110 and by a file extension 210 on a plane representation in accordance with one embodiment of the present application is provided. The representation has two dimensions brought by an x-axis 100 and y-axis 200 and will be referred to as a “plane representation” throughout the present application. For purposes of illustration, the files can be sorted and grouped by the first letter 110 of their file name representing one attribute in the x-axis 100 and they have also been sorted and grouped by their file extension 210 representing a second attribute in the y-axis 200. The characteristics marked on the x-axis 100 can include A, B, C, D, E, . . . X, Y and Z 110. Characteristics on the y-axis 200 can include ADIO, ALFA . . . and VID2 210 or any other available or existing file extension.

In this example, the objects are spheres 240. Each sphere 240 can represent the files in the disk that have filenames that start with a certain letter 110 and have a certain file extension 210, typically at the intersection of the characteristics 110 and 210 for the attributes defined on the x-axis 100 and y-axis 200. The number of files 120 in the disk that start with a certain letter is shown by a number adjacent to each letter 110 on the x-axis 100. The number of files 220 in the disk that have a certain file extension 210 is shown next to each file extension on the y-axis 200. Combining this information, the number of files 230 in the disk that have a filename that starts with a certain letter 110 and have a certain file extension 210 is represented by a number 230 inside each sphere 240. Alternatively, the number 230 can be represented alongside the sphere 240. Through the system described above, files can be separated from others according to two attributes, the starting letter 110 of the filename and the file extension type 210.

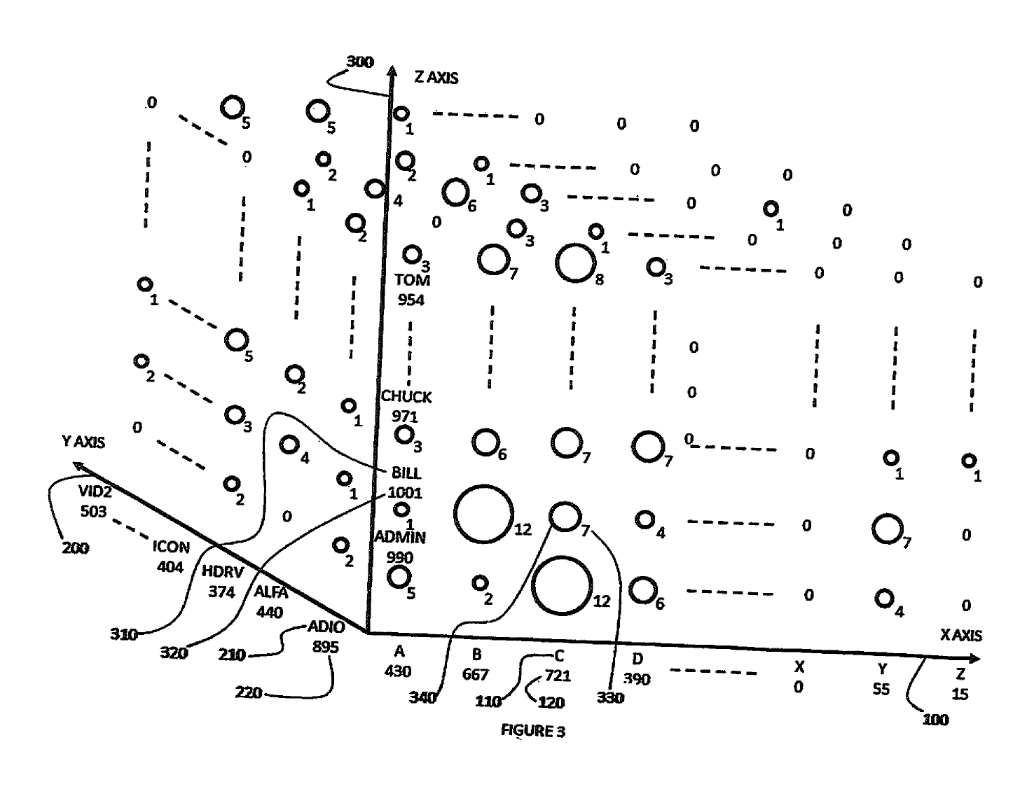

Referring to FIG. 3, an exemplary graphical representation of the files in a computer illustratively grouped and sorted by a filename's first letter 110, file extension 210 and owner 310 on a cube representation in accordance with one embodiment of the present application is provided. The files in a computer disk have been sorted and grouped by the first letter 110 of their file name representing one attribute in the x-axis 100, they have been sorted and grouped by their file extension 210 representing another attribute in the y-axis 200 and they have been sorted and grouped by the file owner 310 representing another attribute in the z-axis 300.

In this example the objects are spheres 340. Typically, each sphere can represent the files in the disk that have filenames that start with a certain letter 110, have a certain file extension 210 and belong to a certain owner 310. The characteristics marked on the x-axis 100 can include A, B, C, D, E, . . . X, Y and Z 110. Characteristics on the y-axis 200 can include ADIO, ALFA, HDRV, ICON, . . . and VID2 210 or any other available or existing file extension, while characteristics on the z-axis 300 can include ADMIN, BILL, CHUCK, . . . TOM 310, or any other existing file owner.

The number of files 120 in the disk that start with a certain letter 110 can be shown by a number adjacent to each letter. The number of files 220 in the disk that have a certain file extension 210 can be shown next to each file extension. The number of files 320 in the disk that belong to a certain owner 310 is shown next to each owner. Combined, the number of files in the disk that have a filename that starts with a certain letter 110, have a certain file extension 210 and belong to a certain owner 310 can be represented by a number 330 by each sphere 340. As this representation has three dimensions, it can be referred to as a “cube representation” throughout the present application.

The size of the objects can be associated with the number of items those objects represent. In FIG. 1, the sphere 130 can become larger with more files 120. In FIG. 2, the sphere 240 can become larger with more files 230 and similarly, in FIG. 3, the sphere 340 can become larger with more files 330. Since one use of the system is to find and identify a single desired data item among a number of items, the ability of inverting the size of the spheres 130, 240 and 340 can be provided. The objects can be manipulated in a way such that larger numbers of data items can be shown in small sizes and objects that represent fewer items can be shown in large sizes.

While a filename's first letter 110, file extension 210 and owner 310 were described, those skilled in the relevant art will appreciate that different attributes can be used and are not limited to those provided above. Different characteristics for each of the attributes can also be implemented.

FIG. 4 depicts illustrative controls for viewing the three dimensional interface in accordance with one embodiment of the present application. As provided above, an x-axis 100, x-axis 100 with y-axis 200 or x-axis 100 with y-axis 200 and z-axis 300 can be implemented.

In one embodiment, the screen can have a left pane 400 that operates in a three dimensional environment and displays the line, plane or cube representations with the timeline and color features. This three dimensional environment allows the user to enter the space and navigate through it. The representations can also be provided outside the interface provided in FIG. 4, for example, the three dimensional interface can be provided on a graphical user interface and not associated with any particular pane. For instance, weather.com allows the user to download a weather tracker that is provided for on top of a graphical user interface. The weather tracker automatically updates and displays without the user's request. Operations can also be provided in different formats that are not listed below.

A right pane 405 can list all the items that have been selected on the left pane 400. The representation shown on left pane 400 can be rotated, panned, zoomed in or out and cropped. In operation, the attribute to be represented on the x-axis 100 can be selected with a pull down menu 410 on the screen. Once the x-axis 100 has been defined, the user can choose to select or filter certain characteristics with this attribute using the pull down menu 411. The user can also choose to sort these items in an ascending, descending or manual way using the pull down menu 412.

The attributes to be represented on the y-axis 200 can be selected with the pull down menu 420. Once the y-axis 200 has been defined, the user can choose to select or filter certain items according to this attribute using the pull down menu 421. The user can also choose to sort these items in an ascending, descending or manual way using the pull down menu 422.

The attribute to be represented on the z-axis 300 can be selected with the pull down menu 430. Once the z-axis 300 has been defined, the user can choose to select or filter certain items according to this attribute using the pull down menu 431. The user can also choose to sort these items in an ascending, descending or manual way using the pull down menu 432.

Those skilled in the relevant art will appreciate that other techniques for selecting attributes and characteristics can be used and are not limited to pull down menus. Furthermore, while an x-axis 100, y-axis 200 and z-axis 300 were used to generate a cube representation, one or two axes can be used to generate a line representation or plane representation, respectively. According to the items selected in the left pane 400, the program can automatically list all the selected items in the right pane 405. In one embodiment, columns displayed in pane 405 can be sorted in different order and also, different columns can be selected for display.

In one embodiment, the user can also choose a fourth attribute. This fourth attribute can be any available one, but this feature works best when this attribute is time-related. Let us suppose that the user wishes to select the year of creation of the files in a disk. To do so, they would use drop down menu 440. The user can choose to manually select a year of creation using drop down menu 441 or they can choose to see a “movie” formed by a sequence of three dimensional layouts, each one of them associated to the year of creation of the file, by pressing the “play” button 444. When the user wishes to stop this movie, they can do so by pressing the “stop” button 443. If the user wishes to see the movie in reverse, they can do so by pressing the “rewind” button 442.

Those skilled in the relevant art will notice that there are other ways to achieve similar effects. For instance there could be other buttons such as pause, fast forward, etc. or there could be a bar and the user could drag a box in the bar to navigate through the different years. As mentioned above, this feature can also be used with other attributes, not necessarily time-related. If the user chose to associate this fourth dimension to the file extension of the files in a computer disk, the program would sort them alphabetically and the user would be able to see a movie of three dimensional layouts formed by frames, each of which would have a layout representing files of one particular file extension. For instance, the first frame would show files with the “ADM” file extension, the second frame would show files with the “ALFA” extension, the third frame would show the “HDRV” extension and so forth.

The objects 130, 240 and 340 in the three dimensional display can have different colors. These colors can be associated to a fifth attribute of the items they represent. For instance, in the example of files in a computer disk, the user could associate the size of the files to a color scale. Files of less than ten bytes can be associated to white, while files bigger than one gigabyte can be associated to red. Files in the intermediate ranges can be associated to different shades or tones of red, with a gradient of lighter colors for small file sizes to darker colors for bigger file sizes. Patterns can also be provided to indicate the sizes instead of colors. Known to those skilled in the relevant art, different attributes can be represented.

In one embodiment, the user can choose an attribute, for example the size of the files in a computer disk using the drop down menu 460. The program would then create a color code such that, for example, files with sizes in the range of 1 to 999 bytes can be green, files with sizes in the range of 1 kilobyte to 999 kilobytes can be light green, files with sizes in the range of 1 megabyte to 999 megabytes can be yellow, files with sizes in the range of 1 gigabyte to 999 gigabytes can be orange and files bigger than 1 terabyte can be red. This color code can be represented in FIG. 4 by the color code 465. The color code 465 for each color can be in addition, or substituted with, a different pattern. As with the other attributes, the user is able to filter the files of a certain size, through the user of the drop down menu 461.

Previously, five different colors were provided. Those skilled in the relevant art, however, will appreciate that fewer or more colors can be used and the color code can also be a color scale formed by a continuum of different tones of one single color. The spheres in the graphical representation can change accordingly as it will be further explained in FIGS. 6 and 7.

The number of files, as represented by 120, 220, 320 and 330, can be turned on or off by the user at will to provide a better visualization through the screen provided in FIG. 4. Generally, pane 450 is provided on a graphical user interface for navigating through a plurality of files. One possible embodiment of this pane will be described in FIG. 5.

This navigation interface can allow a user to navigate in a space of more than three dimensions, besides the time line and color features. This can be achieved by the following illustration. Those skilled in the relevant art will appreciate that are numerous ways to navigate through the information. Suppose, initially, that the user has generated a three dimensional display in the form of a “cube representation”. The user can select one individual sphere of this display and define the elements represented by this sphere as a new starting point or space to navigate. This can be performed by selecting the desired sphere and pressing “Space” button 470. Once this is completed, the program can clear or reset the previous axis-attribute relationships and allow the user to further associate each axis to a new attribute.

In this way, the user can continue to navigate in a fourth, fifth and sixth dimension. In further detail, and continuing with the illustration provided above, suppose that the user defined a cubic representation where the x-axis 100 is associated to the first letter of the file name, the y-axis 200 is associated to the file extension and the fourth axis is associated to the file owner. Also, suppose that the user wants to further “drill” in one of the spheres of this representation and that this sphere is the one that represents files that start with an “S”, that have a file extension “ADIO” and whose owner is “Chuck”. The user can select the aforementioned sphere and press the “Space” button 470. The program can then allow the user to associate the x, y and z axes 100, 200 and 300 to other unused attributes.

Suppose that the user wishes to associate the file size to the x-axis 100, a user defined “Category” to the y-axis 200 and the year of creation to the time axis. In this way the user can have the ability to navigate in a new three dimensional virtual space comprised of a “fourth dimension” of file size, a “fifth dimension” of file category and a “sixth dimension” of time. It will be apparent by those skilled in the relevant art that this procedure can be repeated and the user can “drill” into another sphere creating further new “spaces” and navigating in “n” dimensions.

FIG. 5 provides an exemplary navigation interface in accordance with one embodiment of the present application. The navigation interface allows for management of these representations. The user can rotate the visualization up by pressing button 510, rotate it right by pressing button 511, rotate it down by pressing button 512 or rotate it left by pressing button 513. The user can pan up by pressing button 520, pan right by pressing button 521, pan down by pressing button 522 or pan left by pressing button 523. The user can also zoom-in by pressing button 530 or zoom-out by pressing button 532. This navigation interface is merely an example of how the navigation could be accomplished. Known to those skilled in the relevant art, other ways of managing the layouts can be achieved by the use of keyboard keys, mouse, track ball, touch pad, touch screen or any other device with the ability to interpret human movements or hand gestures. All the representations have the ability to be rotated, paned, zoomed in, zoomed out or cropped in order to provide an easy way of visualization, selection and navigation.

Although the process of arranging data in a certain three dimensional layout is simple, it can often take several steps of sorting and filtering to reach the desired view. To simplify this, the system and method described in the present application can allow a user to save preferred views in a “library” in order to access the desired three dimensional representations quickly and simply. The system can thereafter provide pre-set views for line, plane or cube representations as well as the possibility to save user altered views. Illumination and shades can also be customized and saved.

Another feature that allows users to have a desired view in a quick way is the ability to save certain desired file selections. A normal computer can contain hundreds of thousands of files where many of them are irrelevant to the regular user such as hidden, temporary or system files. In this case the unwanted files can be filtered in order to reduce the amount to a manageable size. Furthermore the user can select how to present information in the disk on different axes 100, 200 and 300 plus the timeline and color features in a way that suits them. Once this is done the user can save this selection for future reference.

Referring now to FIG. 6, features and relational data for an exemplary sphere 240 in accordance with one embodiment of the present application is provided. This can also relate to spheres 130 and 340. As described above, spheres 130, 240 and 340 represent a number of files, records, etc. having common characteristics. To further breakdown information, these objects can be partitioned. In one embodiment, the sphere 240 can be partitioned into segments of different colors or patterns 610, 620, 630, 640 and 650. The top segment 610 can represent a group of files that were created at an earliest time while segment 650 represents a group of files that were created at the latest time. The number of items 615, 625, 635, 645 and 655 for the segments 610, 620, 630, 640 and 650 can be provided on the sphere 240. In one embodiment, the segments 610, 620, 630, 640 and 650 can be split vertically instead of horizontally on the sphere 240. In another embodiment instead of using segments, the program can show spots of different colors.

While sphere 240 was used, the other spheres 130 and 340 can incorporate the partitioning described above. Other characteristics can be represented through the partitioning. Attributes, such as location of the file, number of times updated, etc. can be easily separated and provided within the sphere 240. Furthermore, representations can be rotated while showing a sequence of cubes with colored spheres 130, 240 and 340 associated to data groups.

With reference now to FIG. 7, exemplary objects clustered for use with the illustrative graphical representation of files in accordance with one embodiment of the present application is provided. Another way of splitting the information represented by a sphere is shown. In this case, for example, files with the file extension “ADIO”, whose file name start with an “A” that belong to the owner “ADMIN” were originally represented by one single colored sphere containing five items. Through the use of the color feature as previously explained, this single sphere can be split into four smaller spheres each of them of a different color, or pattern, representing the amount of files of different sizes. The user can visualize that there are two files that have file sizes in the order of megabytes, one file has a file size in the order of gigabytes, one file has a file size in the order of the terabytes and one file has a file size in the order of bytes. Through the use of the color or pattern feature the program can allow the user to see a “fifth dimension” in this space.

The objects arranged in these representations can have any shape. Typically for the sake of simplicity and symmetry these objects would be spheres 130, 240 and 340. In order to make the environment more user-friendly and visually compelling, these objects 130, 240 and 340 can have several different shapes and backgrounds allowing the creation of themes. For example, the spheres 130, 240 and 340 could be colored in a plain background creating a geometrical environment. Another alternative is to make these objects 130, 240 and 340 star shaped, in a dark background resembling a space environment. Other possible themes can be planets, galaxies, fruits, bubbles, toys, etc.

An additional advantage of the system described herein can be the navigation and browsing features provided for the three dimensional structures. In a free navigation mode, with the aid of a pointing device the three dimensional layouts can be paned. Depending on the hardware, the point device can be a mouse, trackball, stylus or even the user's finger. When the number of objects is too big making free navigation cumbersome, one alternative is to navigate and select by planes. In this plane navigation mode, the user can select a plane parallel to the “xy”, “yz” or “xz” planes and navigate the three dimensional structure and select objects one plane at a time.

One further step is to navigate by lines. The user can select a line parallel to the “x”, “y” or “z” axes and navigate the three dimensional structure and select objects one line at a time. Using the aforementioned navigation methods the user can select a single object, a line of objects, a plane of objects or a cube of objects. Each time an individual object or group of objects 130, 240 and 340 are selected this method lists all the data items that correspond to the selected objects in pane 405.

Each time a line or plane selection is made, it can be further expanded by another attribute. In the example, where the x-axis 100 is associated with the first letter of the file name, the y-axis 200 is associated with the extension of the file name, the z-axis 300 is associated with the owner of the file and t-axis is associated with the year of creation, the user can select a plane that includes all filenames, all owners and all creation years of files with extension equal to “.SPST” producing a new layout that will be represented by a plane and a time-line. The user can now expand this plane back into a cube by re-associating the y-axis 200 to the category of the files allowing further navigation and selection.

The same concept can be used to expand a line on to a plane. If the user selected the files with “.SPST” extension, whose owner is “John”, that start with any file name letter and have been created in any year the user would obtain a line selection. This line can be expanded on to a plane if the user re-associated the y-axis 200 to the “author” of the files. After the user gets to select a data item or group of data items, the user can perform several actions including, but not limited to, deleting, duplicating, moving, executing, opening, sending and printing the data items.

FIG. 8 is an exemplary block diagram that shows an illustrative computer architecture used for running the three dimensional interface in accordance with one aspect of the present application. Typically, the processing can be performed on a client computer 802, which includes a processing unit 804, a system memory 806, and a system bus 820 that operatively couples various system components, including the system memory 806 to the processing unit 804. There can be only one or there can be more than one processing unit 804, such that the processor of computer 802 comprises a single central processing unit (CPU), or a plurality of processing units, commonly referred to as a parallel processing environment. The computer 802 can be a conventional computer, a distributed computer, a web server, a file server, or any other type of computer.

The system bus 820 can be any of several types of bus structures including a memory bus or memory controller, a peripheral bus, a switched fabric, point-to-point connections, and a local bus using any of a variety of bus architectures. The system memory 806 can also be referred to as simply the memory, and includes read only memory (ROM) 808 and random access memory (RAM) 807. A basic input/output system (BIOS) 810, containing the basic routines that help to transfer information between elements within the computer 802, such as during start-up, is stored in ROM 808. The computer 802 further includes a hard disk drive 832 for reading from and writing to a hard disk, not shown, a magnetic disk drive 834 for reading from or writing to a removable magnetic disk 838, and an optical disk drive 836 for reading from or writing to a removable optical disk 840 such as a CD ROM or other optical media. Memory cards such as SanDisk™, MicroSD™, pen drives, external hard drives or any other kind of storage device can be used.

The hard disk drive 832, magnetic disk drive 834, and optical disk drive 836 can be connected to the system bus 820 by a hard disk drive interface 822, a magnetic disk drive interface 824, and an optical disk drive interface 826, respectively. The drives and their associated computer-readable medium provide nonvolatile storage of computer-readable instructions; data structures, e.g., a catalog and a contextual-based index; program modules, e.g., a web service and an indexing robot; and other data for the computer 802. It should be appreciated by those skilled in the art that any type of computer-readable medium that can store data that is accessible by a computer, for example, magnetic cassettes, flash memory cards, digital video disks, RAM, and ROM, can be used in the exemplary operating environment.

A number of program modules can be stored on the hard disk 832, magnetic disk, optical disk 836, ROM 808, or RAM 807, including an operating system 812, one or more application programs 814, the three dimensional interface 816 as substantially described above, and program data 818. A user can enter commands and information into the personal computer 802 through input devices such as a keyboard 842 and pointing device 844, for example, a mouse. Other input devices (not shown) can include, for example, a microphone, a joystick, a game pad, a tablet, a touch screen device, a satellite dish, a scanner, a facsimile machine, and a video camera. These and other input devices are often connected to the processing unit 804 through a serial port interface 828 that is coupled to the system bus 820, but can be connected by other interfaces, such as a parallel port, game port or a universal serial bus (USB).

A monitor 846 or other type of display device can also be connected to the system bus 820 via an interface, such as a video adapter 848. In addition to the monitor 846, computers typically include other peripheral output devices, such as a printer and speakers 860. These and other output devices are often connected to the processing unit 804 through the serial port interface 828 that is coupled to the system bus 820, but can be connected by other interfaces, such as a parallel port, game port, or a universal serial bus (USB).

The computer 802 can operate in a networked environment using logical connections to one or more remote computers. These logical connections can be achieved by a communication device coupled to or integral with the computer 802; the application is not limited to a particular type of communications device. The remote computer can be another computer, a server, a router, a network personal computer, a client, a peer device, or other common network node, and typically includes many or all of the elements described above relative to the computer 802, although only a memory storage device has been illustrated in FIG. 8. Computer 802 can be logically connected to the Internet 872. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks. Files for the three dimensional system can be stored in ROM 806, RAM 807, other storage facility or the Internet 872.

When used in a LAN environment, the computer 802 can be connected to the local network through a network interface or adapter 830, which is one type of communication device. When used in a WAN environment, the computer 802 typically includes a modem 850, a network adapter 852, or any other type of communications device for establishing communications over the wide area network. The modem 850, which can be internal or external, is connected to the system bus 820 via the serial port interface 828. In a networked environment, program modules depicted relative to the personal computer 802, or portions thereof, can be stored in a remote memory storage device. It is appreciated that the network connections shown are exemplary and other means of and communications devices for establishing a communications link between the computers can be used.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. Furthermore, it should be understood that logical operations can be performed in any order, unless explicitly claimed otherwise or a specific order is inherently necessitated by the claim language.

Client computer 802, as described above, was exemplary and should not be construed as limiting. Client computer 802 typically encompasses many types of other devices. Such devices can include a cell phone, personal digital assistant (PDA), stationary personal computer, IPTV remote control, web tablet, laptop computer, pocket PC, a television set capable of receiving IP based video services and mobile IP device, players, etc, The system can also be used in other electronic devices, for example, standalone or network computers, notebooks, netbooks, MP3 players, compact disk or DVD players, hard disks, soft disks, memories, pen drives or any device capable of storing information.

The three dimensional interface 816 can take the form of an entirely hardware embodiment, an entirely software embodiment or an embodiment containing both hardware and software elements. In one embodiment, the interface 816 is implemented in software, which includes but is not limited to firmware, resident software, microcode, etc. Furthermore, the interface 816 can take the form of a computer program product accessible from a computer-usable or computer-readable medium providing program code for use by or in connection with a computer or any instruction execution system. For the purpose of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium can include a semiconductor or solid-state memory, magnetic tape, a removable computer diskette, a random access memory (RAM), a red-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code can include at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers. Network adapters can also be coupled to the computer 802 to enable the data processing system to become coupled to other data processing systems or remote printers or storage devices through intervening private or public networks. Modems, cable modem and Ethernet cards are just a few of the currently available types of network adapters.

Described above, aspects of the present application can be embodied in a World Wide Web (“WWW”) or (“Web”) site accessible via the Internet 872. As is well known to those skilled in the art, the term “Internet” refers to the collection of networks and routers that use the Transmission Control Protocol/Internet Protocol (“TCP/IP”) to communicate with one another. The Internet 872 can include a plurality of local area networks (“LANs”) and a wide area network (“WAN”) that are interconnected by routers. The routers are special purpose computers used to interface one LAN or WAN to another. Communication links within the LANs can be wireless, twisted wire pair, coaxial cable, or optical fiber, while communication links between networks can utilize 56 Kbps analog telephone lines, Mbps digital T-1 lines, 45 Mbps T-3 lines or other communication links known to those skilled in the art.

Furthermore, computers and other related electronic devices can be remotely connected to either the LANs or the WAN via a digital communication device, modem and temporary telephone, or a wireless link. It will be appreciated that the Internet 872 comprises a vast number of such interconnected networks, computers, and routers.

The Internet 872 has recently seen explosive growth by virtue of its ability to link computers located through the world. As the Internet 872 has grown, so has the WWW. As is appreciated by those skilled in the art, the WWW is a vast collection of interconnected or “hypertext” documents written in HyperText Markup Language (“HTML”) or other markup languages that are electronically stored at or dynamically generated by “WWW sites” or “Web sites” throughout the Internet 872. Additionally, a client-side software program that communicates over the Web using the TCP/IP protocol can be part of the WWW, such as JAVA® applets, instant messaging, e-mail, browser plug-ins, Macromedia Flash, chat and others. Other interactive hypertext environments can include proprietary environments such as those provided in America Online or other online service providers, as well as the “wireless Web” provided by various wireless networking providers, especially those in the cellular phone industry. It will be appreciated that the present application could apply in any such interactive communication environments; however, for purposes of discussion, the Web is used as an exemplary interactive hypertext environment with regard to the present application.

A Web site is a server/computer connected to the Internet 872 that has massive storage capabilities for storing hypertext documents and that runs administrative software for handling requests for those stored hypertext documents as well as dynamically generating hypertext documents. Embedded within a hypertext document are a number of hyperlinks i.e., highlighted portions of text which link the document to another hypertext document possibly stored at a Web site elsewhere on the Internet 872. Each hyperlink is assigned a Uniform Resource Locator (“URL”) that provides the name of the linked document on a server connected to the Internet 872. Thus, whenever a hypertext document is retrieved from any web server, the document is considered retrieved from the World Wide Web. Known to those skilled in the art, a web server can also include facilities for storing and transmitting application programs, such as application programs written in the JAVA® programming language from Sun Microsystems, for execution on a remote computer. Likewise, a web server can also include facilities for executing scripts and other application programs on the web server itself.

A remote access user can retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext documents from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser can also retrieve programs from the web server, such as JAVA applets, for execution on the client computer. Finally, the WWW browser can include optional software components, called plug-ins, that run specialized functionality within the browser.

In accordance with one aspect of the present application, a user computer system having a display screen and a graphical user interface provided for on the display screen for navigating through a plurality of files is provided. The system can include at least one processor and a memory operatively coupled to the processor, the memory storing program instructions that when executed by the processor, causes the processor to perform processes. The processes can include determining at least three attributes for the plurality of files and associating characteristics of the at least three attributes to an x-axis, y-axis and z-axis on a three dimensional space in the graphical user interface. In addition, the processes can include mapping at least one object on the three dimensional space in the graphical user interface indicating a number of files from the plurality of files having common characteristics defined at an intersection of the characteristics associated with the at least three attributes on the x-axis, y-axis and z-axis.

In one embodiment, the object can be a sphere. In one embodiment, the sphere indicating the number of files can be larger when representing a greater number of the files and smaller when representing a fewer number of the files. In one embodiment, the sphere can be colored representing the number of files. In one embodiment, the sphere can be patterned representing the number of files.

In one embodiment, the memory storing program instructions, when executed by the processor, can cause the processor to expand the at least one object showing the number of files from the plurality of files within the graphical user interface. In one embodiment, the graphical user interface can include new attributes. In one embodiment, the memory storing program instructions, when executed by the processor, can cause the processor to receive instructions for executing a file within the object and launching the file contained within the object.

In one embodiment, the memory storing program instructions, when executed by the processor, can cause the processor to at least rotate, pan, zoom-in, zoom-out or crop the three dimensional space in the graphical user interface. In one embodiment, the memory storing program instructions, when executed by the processor, can cause the processor to pan the clustered two or more objects creating a succession of ball clusters in a dynamic, movie-like fashion.

In accordance with another aspect of the present application, a computer-implemented method for visualizing records is provided. The method can include determining at least one attribute for the records and associating at least one axis with characteristics of the at least one attribute. In addition, the method can include deciding on a number of records that have at least one common characteristic according to said characteristics of said at least one attribute and generating at least one object according to the decision. The method can also include mapping the at least one object at the at least one common characteristic associated with the characteristics of the at least one attribute on the at least one axis.

In one embodiment, the method can include manipulating a view of the at least one object and axis. In one embodiment, the method can include mapping the at least one object on a line representation. In one embodiment, the method can include mapping the at least one object on a plane representation. In one embodiment, the method can include mapping the at least one object on a cube representation. In one embodiment, the method can include turning on or off the at least one object.

In accordance with yet another aspect of the present application, a system for organizing and traversing through files using logic executed by at least one processor is provided. The system can include cube representation logic defining an x-axis, y-axis and z-axis on a three dimensional space, the x-axis, y-axis and z-axis each associated with an attribute having characteristics. In addition, the system can include generation logic defining at least one sphere indicating a number of files associated with characteristics of the attributes on the x-axis, y-axis and z-axis, the at least one sphere placed within the three dimensional space corresponding to the characteristics of the attributes on the x-axis, y-axis and z-axis. The system can also include navigating logic defining options for visualizing the at least one sphere on the three dimensional space.

In one embodiment, the navigating logic can allow access of the files indicated by the sphere. In one embodiment, the navigating logic can provide the files indicated by the sphere in a new space. In one embodiment, the generation logic can provide the object with a fourth dimension and fifth dimension.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A user computer system having a display screen and a graphical user interface provided for on said display screen for navigating through a plurality of files, said system comprising:
at least one processor; and
a memory operatively coupled to said processor, said memory storing program instructions that when executed by said processor, causes said processor to:
determine at least three attributes for said plurality of files;
associate characteristics of said at least three attributes to an x-axis, y-axis and z-axis on a three dimensional space in said graphical user interface;
map at least one object on said three dimensional space in said graphical user interface indicating a number of files from said plurality of files having common characteristics defined at an intersection of said characteristics associated with said at least three attributes on said x-axis, y-axis and z-axis.

2. The user computer system of claim 1, wherein said object is a sphere.

3. The user computer system of claim 2, wherein said sphere indicating said number of files is larger when representing a greater number of said files and smaller when representing a fewer number of said files.

4. The user computer system of claim 2, wherein said sphere is colored representing said number of files.

5. The user computer system of claim 2, wherein said sphere is patterned representing said number of files.

6. The user computer system of claim 1, wherein said memory storing program instructions, when executed by said processor, causes said processor to expand said at least one object showing said number of files from said plurality of files within said graphical user interface.

7. The user computer system of claim 6, wherein said graphical user interface comprises new attributes.

8. The user computer system of claim 1, wherein said memory storing program instructions, when executed by said processor, causes said processor to receive instructions for executing a file within said object and launching said file contained within said object.

9. The user computer system of claim 1, wherein said memory storing program instructions, when executed by said processor, causes said processor to at least rotate, pan, zoom-in, zoom-out or crop said three dimensional space in said graphical user interface.

10. The user computer system of claim 9, wherein said memory storing program instructions, when executed by said processor, causes said processor to display said clustered two or more objects creating a succession of ball clusters in a dynamic, movie-like fashion.

11. A computer-implemented method for visualizing records comprising:
determining at least one attribute for said records;
associating at least one axis with characteristics of said at least one attribute;
deciding on a number of records that have at least one common characteristic according to said characteristics of said at least one attribute;
generating at least one object according to said decision; and
mapping said at least one object at said at least one common characteristic associated with said characteristics of said at least one attribute on said at least one axis.

12. The computer-implemented method of claim 11, comprising manipulating a view of said at least one object and axis.

13. The computer-implemented method of claim 11, comprising mapping said at least one object on a line representation.

14. The computer-implemented method of claim 11, comprising mapping said at least one object on a plane representation.

15. The computer-implemented method of claim 11, comprising mapping said at least one object on a cube representation.

16. The computer-implemented method of claim 11, comprising turning on or off said at least one object.

17. A system for organizing and traversing through files using logic executed by at least one processor, said system comprising:
cube representation logic defining an x-axis, y-axis and z-axis on a three dimensional space, said x-axis, y-axis and z-axis each associated with an attribute having characteristics;
generation logic defining at least one sphere indicating a number of files associated with characteristics of said attributes on said x-axis, y-axis and z-axis, said at least one sphere placed within said three dimensional space corresponding to said characteristics of said attributes on said x-axis, y-axis and z-axis; and
navigating logic defining options for visualizing said at least one sphere on said three dimensional space.

18. The system of claim 17, wherein said navigating logic allows access of said files indicated by said sphere.

19. The system of claim 17, wherein said navigating logic provides said files indicated by said sphere in a new space.

20. The system of claim 17, wherein said generation logic provides said object with a fourth dimension and fifth dimension.
